(19) United States
(12) Patent Application Publication
(10) Pub. No.: US 2026/0267503 A1
(43) Pub. Date: Sep. 10, 2026

(54) INPUT DEVICE AND INPUT SYSTEM FOR CHARACTER CODE

(71) Applicant: Nichido Solutions Inc., Sakaiminato-shi (JP)

(72) Inventors: Ali Cemal DOGAL, Tottori (JP); Kenta Selim ISHIDA, Tottori (JP); Kohei Halil ISHIDA, Tottori (JP)

(73) Assignee: Nichido Solutions Inc., Sakaiminato-shi (JP)

(21) Appl. No.: 19/415,763

(22) Filed: Dec. 10, 2025

Related U.S. Application Data
(63) Continuation of application No. PCT/JP2025/008398, filed on Mar. 7, 2025.

(51) Int. Cl. G06F 3/04886

(52) U.S. Cl. CPC G06F 3/04886

(57) ABSTRACT

Provided is an input device for a character code including 27 types of character symbols, each of which is formed by arranging, in a line, three arbitrary character elements selected from among three different types of the character elements, 26 letters of an alphabet and one space symbol being respectively assigned to the character symbols, the input device including: at least one processor; and a display, wherein the processor displays, on the display, a keyboard including a plurality of input key columns arranged side by side in a row direction, each of the input key columns being composed of three input keys arranged in a line in a column direction for inputting one of the character symbols, and allows a user to specify an input key, and cyclically switches and displays the three types of the character elements upon specification of the input key.

### CROSS-REFERENCE TO RELATED APPLICATIONS

This is a continuation of International Application PCT/JP2025/008398, with an international filing date of Mar. 7, 2025, which is hereby incorporated by reference herein in its entirety.

### TECHNICAL FIELD

The present disclosure relates to an input device and an input system for a character code.

### BACKGROUND

One-dimensional barcodes or two-dimensional barcodes have conventionally been known as computer-readable codes (for example, see PTL 1 and PTL 2).

For example, a JAN code (GTIN-13, GTIN-8) as a standard one-dimensional barcode expresses seven zones (modules) by combining two black bars and two white bars for representing a number. In addition, in what is called a customer barcode described in PTL 1, a character is assigned to a code composed of 2-bit, 4-state (upper and lower, upper, lower, and none) three bars arranged with gaps therebetween.

### CITATION LIST

### Patent Literature

### {PTL 1}

Japanese Unexamined Patent Application, Publication No. H9-212569

### {PTL 2}

The Publication of Japanese U.S. Pat. No. 6,034,404

### SUMMARY

An aspect of the present disclosure is directed to an input device for a character code comprising 27 types of character symbols, each of which is formed by arranging, in a line, three arbitrary character elements selected from among three different types of the character elements, 26 letters of an alphabet and one space symbol being respectively assigned to the character symbols, the input device comprising: at least one processor; and a display, wherein the processor displays, on the display, a keyboard comprising a plurality of input key columns arranged side by side in a row direction, each of the input key columns being composed of three input keys arranged in a line in a column direction for inputting one of the character symbols, and allows a user to specify an input key, and cyclically switches and displays the three types of the character elements upon specification of the input key.

### BRIEF DESCRIPTION OF DRAWINGS

FIG. 1 is a diagram showing an example of three character elements constituting a character symbol of a character code to be used for an input device according to an embodiment of the present disclosure.

FIG. 2 is a diagram describing a configuration of the character symbol of the character code in FIG. 1.

FIG. 3 is a diagram showing an example of 27 types of character symbols formed by combining the character elements in FIG. 1, a top row enumerating the 27 types of character symbols, a middle row showing the character symbols with alphabetical assignments, and a bottom row showing the character elements with their frames removed.

FIG. 4 is a schematic diagram showing the input device for a character code according to an embodiment of the present disclosure.

FIG. 5 is a diagram showing an example of display on a display of the input device of FIG. 4.

FIG. 6 is a diagram showing an example of switching between input keys of a keyboard displayed on the display of FIG. 5.

FIG. 7 is a diagram describing a slide input to the keyboard on the display of FIG. 5.

FIG. 8 is a diagram showing an example of display of alphabet letters corresponding to character symbols input to the keyboard on the display of FIG. 5.

FIG. 9 is a diagram showing an example of display of another keyboard on the display of FIG. 5.

FIG. 10 is a diagram showing an example of frequently used words in accordance with the character code in FIG. 1.

FIG. 11 is a diagram showing an example of words similarly to FIG. 10.

FIG. 12 is a diagram showing an example of strokes in a case of a slide input of the character code of FIG. 1 to the keyboard on the input device of FIG. 4.

FIG. 13 is a diagram showing an example of character symbols assigned with alphabet letters D, F, and H in FIG. 3.

FIG. 14 is a diagram showing a preferable example (marked with “O” on the right side) and an undesirable example (marked with “X” on the left side of a word obtained by the first optimization.

FIG. 15 is a diagram showing a preferable example (marked with “O” on the right side) and an undesirable example (marked with “X” on the left side of a word obtained by the second optimization.

FIG. 16 is a diagram showing a preferable example (marked with “O” on the right side) and an undesirable example (marked with “X” on the left side of a word obtained by the third optimization.

FIG. 17 is a diagram showing a preferable example (marked with “O” on the right side) and an undesirable example (marked with “X” on the left side of a word obtained by the fourth optimization.

FIG. 18 is a diagram showing modifications of the character symbol in FIG. 2.

FIG. 19 is a diagram showing an example of character symbols assigned with numbers.

### DESCRIPTION OF EMBODIMENTS

Hereinafter, an input device 10 for a character code according to an embodiment of the present disclosure will be described with reference to the drawings.

First, a character code to be input to the input device 10 will be described.

As shown in FIG. 2, the character code is composed of a character symbol 2 in which three character elements 1 are arranged in a line. The character elements 1 constituting the character symbol 2 are three arbitrary character elements 1 selected from among three different types of character elements 1a to 1c.

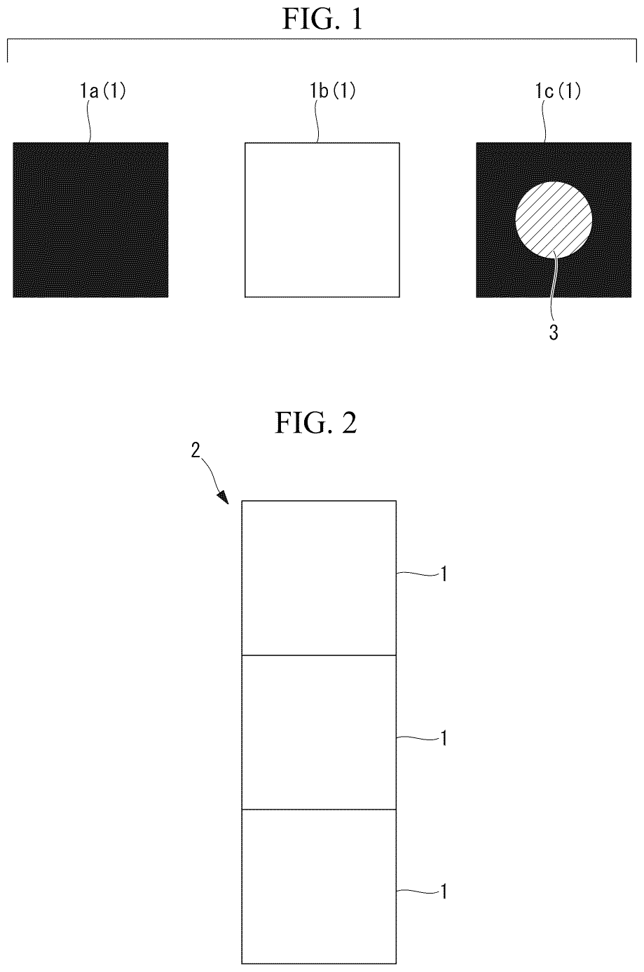

As three types of the character elements 1a to 1c, any elements may be employed as long as they can be recognized as different from each other. In the present embodiment, as shown in FIG. 1, the first character element 1a, the second character element 1b, and the third character element 1c, each formed by a square having an identical size and shape, are employed.

In the present embodiment, description is made by taking, for example, a case where a background color of a region in which the character symbol 2 is displayed is white.

The first character element 1a is a square filled with a color different from the background color, such as black.

The second character element 1b is a square filled with the same color as the background color, or a transparent square or a frame thereof.

The third character element 1c is a square having a circular dot 3 at the center, an outside of the dot 3 being filled with the same color as that of the first character element 1a, such as black, and an inside of the dot 3 being filled with a color different from that of the outside, such as green. The dot 3 may be a true circle or may be an ellipse or an oval.

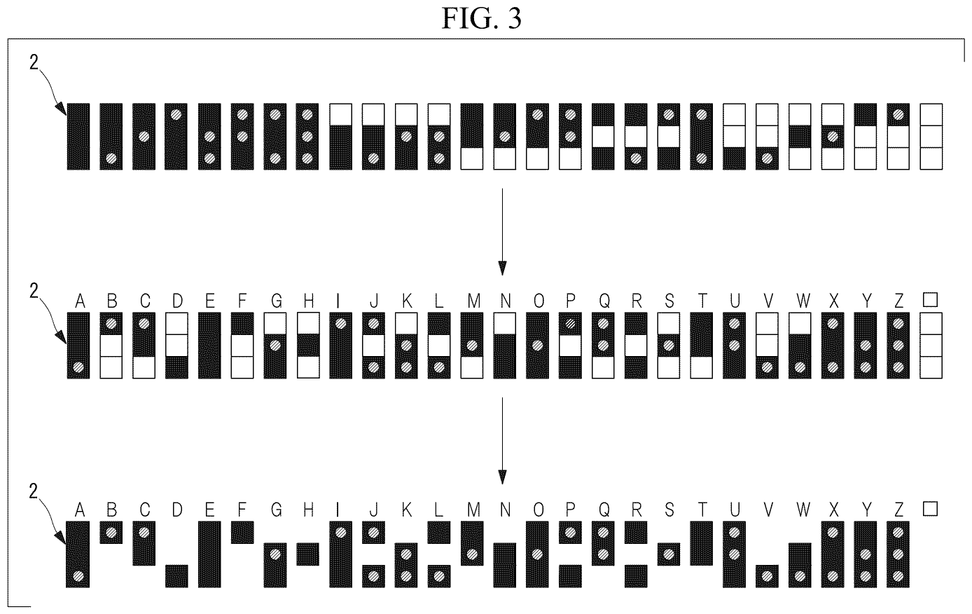

As shown in the top row of FIG. 3, there are 3×3×3=27 types of character symbols 2, in which any three character elements 1 selected from among the three different types of the character elements 1a to 1c are arranged in a line. The character code according to the present embodiment is constituted by assigning 26 letters of the alphabet and one space symbol to these 27 types of character symbols 2.

FIG. 3 shows, in the top row, the 27 types of character symbols 2 constituting the character code according to the present embodiment and shows, in the middle row, an example in which a corresponding letter of the alphabet is assigned to each of these character symbols 2. The bottom row of FIG. 3 shows the 27 types of character symbols 2 in the case where the second character elements 1b in the character symbols 2 in the middle row are squares of the same color as the background color and have no frame.

The assignment of the alphabet letters to the character symbols 2 in the middle row of FIG. 3 is an example and not limited thereto. Any assignment is possible, and a customization function that enables a user to change the assignment may be equipped.

The character code according to the present embodiment is optimized by a method described below.

First, vowels “A”, “E”, “I”, “O”, and “U” of the alphabet are each assigned to any one of the character symbols 2 that are composed of only the first character element 1a, only the third character element 1c, or only the first character element 1a and the third character element 1c. These character symbols 2 have the three character elements 1 composed of entirely black-colored or black-colored squares having the dots 3 and are thus the character symbols 2 (hereinafter referred to as full-height character symbols) of black-colored rectangle having a height equivalent to the three character elements 1.

Since a word usually involves a vowel, the above optimization enables one or more full-height character symbols to be present in a logogram. For a similar reason, the alphabet letter “Y”, which frequently appears in a word, is assigned to any full-height character symbol. Accordingly, a full-height character symbol can also be contained in a word having no vowel, such as “RYTHM”, for example.

Second, the alphabet letters are assigned to the character symbols 2 so as to ensure at least one linkage in the lateral direction between adjacent two character symbols 2 in many words.

Third, the assignment of the alphabet letters to the character symbols 2 is optimized using frequency analysis of a large-scale corpus so as to minimize the number of the dots 3.

Fourth, the assignment of the alphabet letters to the character symbols 2 is optimized using frequency analysis of the large-scale corpus so as to reduce the number of required black-colored squares to the minimum. For example, less frequently used X and Z are assigned to any one of the full-height character symbols.

These types of optimizations are performed automatically by an algorithm.

Next, the input device 10 according to the present embodiment will be described.

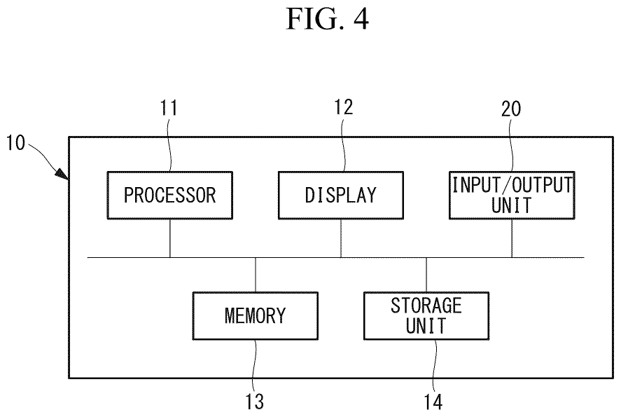

The input device 10 according to the present embodiment includes at least one processor 11, a display 12, at least one memory 13, a storage unit 14, and an input/output unit 20 as shown in FIG. 4.

The processor 11 is constituted by a CPU, a quantum processor, or the like. The display 12 is constituted by a liquid crystal display device, an organic EL display device, or the like. In the present embodiment, the display 12 is a touch screen and also functions as a user interface that receives user operation by being controlled by the processor 11.

The memory 13 is constituted by a DRAM or the like and temporarily stores data necessary for the processor 11 to execute processing. In particular, the memory 13 stores the character symbols 2 constituting the character code described above in association with the alphabet letters assigned to each of the character symbols 2, respectively. The storage unit 14 is constituted by a hard disk drive or an SSD, a flash memory, or the like. The storage unit 14 stores an operation program for causing the processor 11 to execute operation which will be described later and data necessary for the operation.

The input/output unit 20 is an input/output interface that communicates with an external device (not shown) under control of the processor 11 to export data stored in the memory 13 to the outside or import data from the external device.

The input device 10 according to the present embodiment is implemented, for example, as a portable terminal such as a smartphone or tablet terminal, or as a personal computer, or the like. Hereinafter, a smartphone is exemplified to illustrate it.

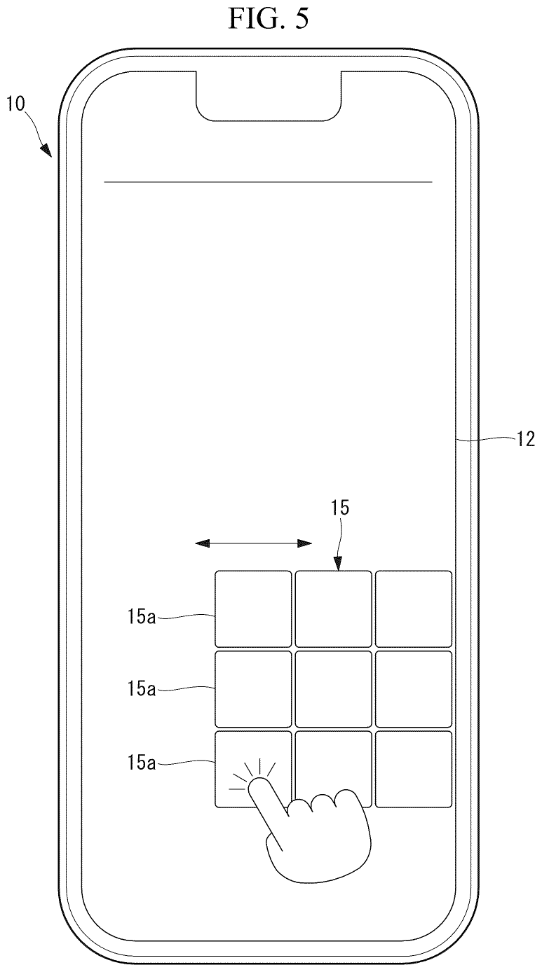

As shown in FIG. 5, the processor 11 displays a keyboard 15 on the display 12. The keyboard 15 is constituted by arranging a plurality of input key columns side by side in a row direction, each of the input key columns being formed by arranging three square-like input keys 15a n a line in a column direction for inputting each of the character symbols 2 of the character code described above.

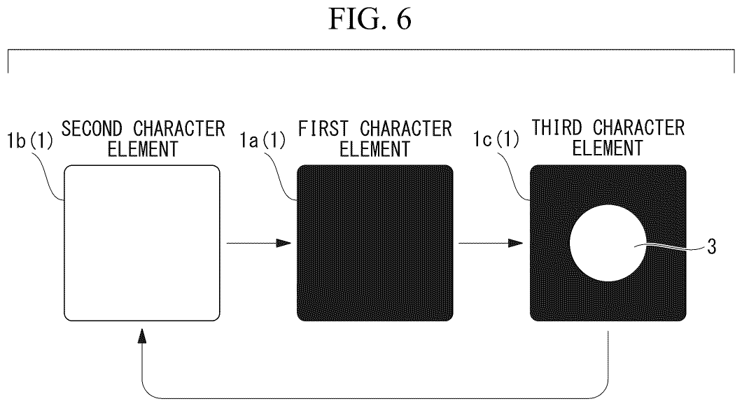

As shown in FIG. 6, each of the input keys 15a of the keyboard 15 displays the second character element 1b in a default state, and displays the first character element 1a when touched once, the third character element 1c when touched once more, and the second character element 1b when touched again. In other words, the processor 11 displays, on each of the input keys 15a, one of the three types of the character elements 1a to 1c, which is cyclically replaced each time the user touches (designates) the input key 15a.

In addition, when designating a plurality of the input keys 15a adjacent to each other in the column direction and the row direction, the keyboard 15 enables designation by a slide input. In other words, when designating a plurality of the input keys 15a adjacent to each other, the user can successively designate the input keys 15a by sliding his/her finger touched on one of the input keys 15a directly over the surface of the display 12 to be slid to the adjacent input key 15a without releasing the finger.

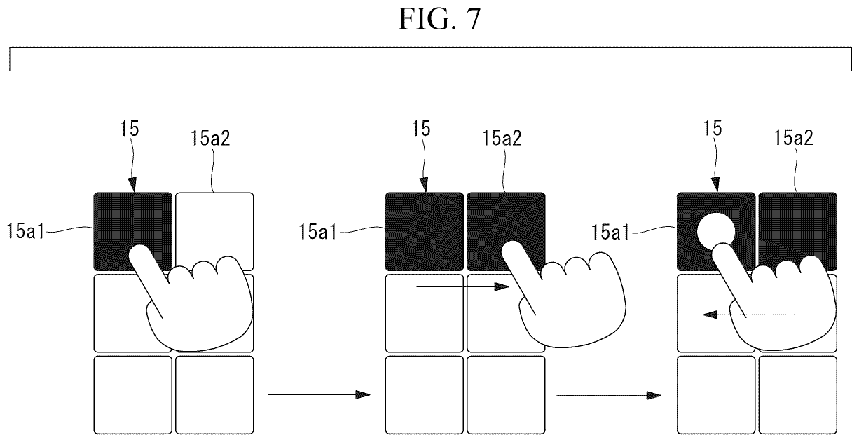

For example, as shown in FIG. 7, when the user touches a first input key 15a1 on which the second character element 1b is displayed and successively slides to and touches an adjacent second input key 15a2, both keys are thereby switched to the first character element 1a. In addition, directly and successively touching the first input key 15a1 again without releasing his/her finger from the second input key 15a2 leads to two touches on the first input key 15a1, which is switched to the third character element 1c.

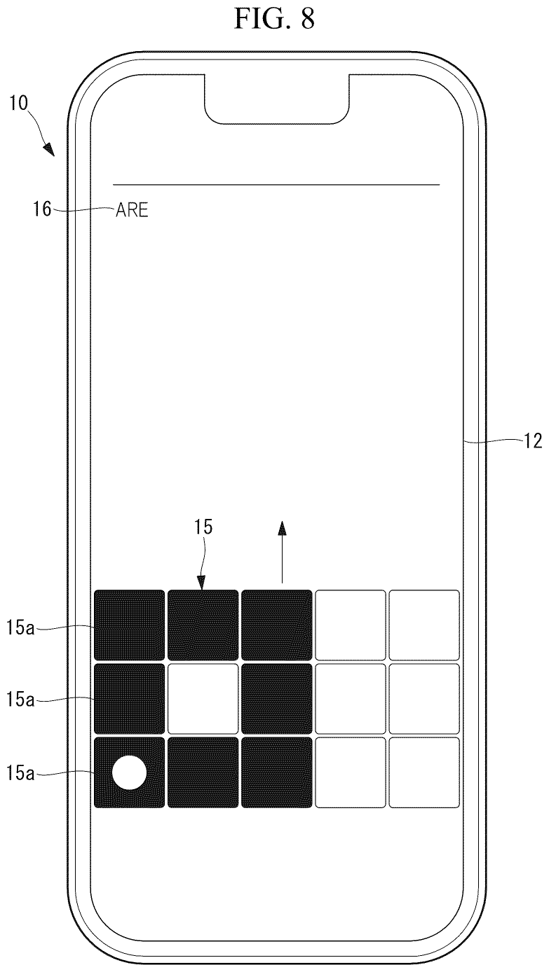

When the character elements 1 are input to an input key column, the processor 11 searches the memory 13 to read out an alphabet letter corresponding to the input character symbol 2. Then, as shown in FIG. 8, the processor 11 displays the alphabet letter in a region (alphabet display region) 16 different from the keyboard 15 on the display 12.

As indicated by arrows in FIG. 5, the keyboard 15 displayed on the display 12 is slidable in the row direction. For example, by the user partially touching a grid constituting the keyboard 15 to drag it in the row direction, the processor 11 slides the keyboard 15 in a drag direction. The processor 11 then additionally displays, on the display 12, another input key column following rearward in the sliding direction of the keyboard 15.

Alternatively, in the case where the user touches any of the input keys 15a and continues slide input in the row direction, the processor 11 adds a new input key column frontward in the slide input direction, and displays it on the display 12. In this case, as shown in FIG. 8, it is preferable that (blank) input key columns, each of which is composed of only the second character element 1b, be displayed in two columns on the right end of the keyboard 15.

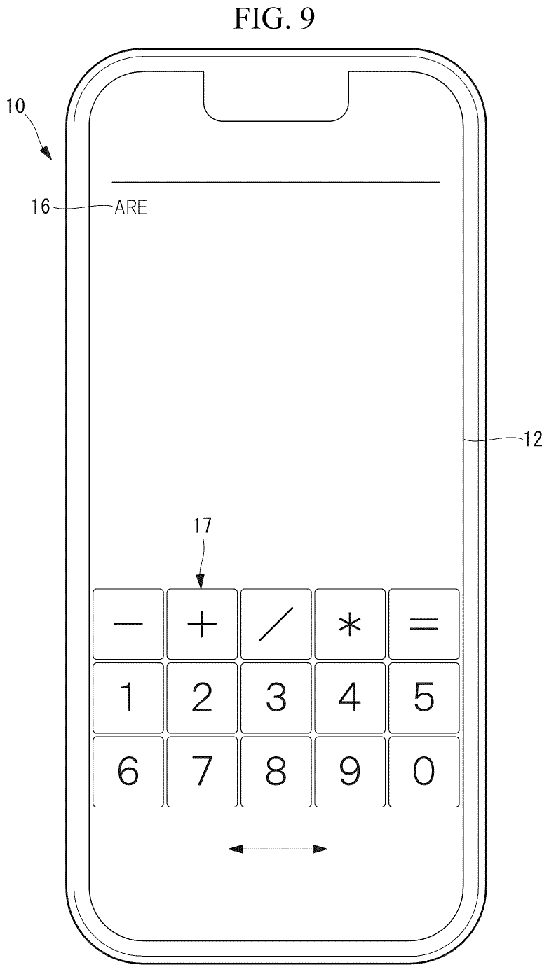

In addition, for example, the user partially touches the grid constituting the keyboard 15 to drag it in the column direction as indicated by an arrow in FIG. 8. Accordingly, the processor 11 switches the keyboard 15 to another keyboard 17 for inputting a numeric value and/or a symbol as shown in FIG. 9. The displayed other keyboard 17 may also be slidable in the row direction so that another symbol or the like can be displayed.

The operation of the input device 10 for the character code according to the present embodiment thus configured will be described below.

According to the input device of the present embodiment, by touching the input key 15a of the keyboard 15 displayed on the display 12, any of the character elements 1a to 1c can be input to the input key 15a in accordance with the number of touches. Then, each time the character elements 1 are input to an input key column in which the three input keys 15a are arranged in a line in the column direction, the processor 11 reads out an alphabet letter corresponding to the character symbol 2 from the memory 13 to display it in the alphabet display region 16. Thus, the user can continue input while checking whether the input character symbol 2 has been input correctly.

Alternatively, in the case where a user who is unfamiliar with the above-described character code checks the meaning of a character code, by inputting the character symbols 2 to the keyboard 15 in handwriting, the meaning can be checked with a displayed alphabet. Even if there is no reading device, the meaning content can be checked easily.

In addition, the input device of the present embodiment may have a recommendation function that enumerates and displays character codes that can be estimated based on the character symbol(s) 2 that have been input, before the character code is entirely input.

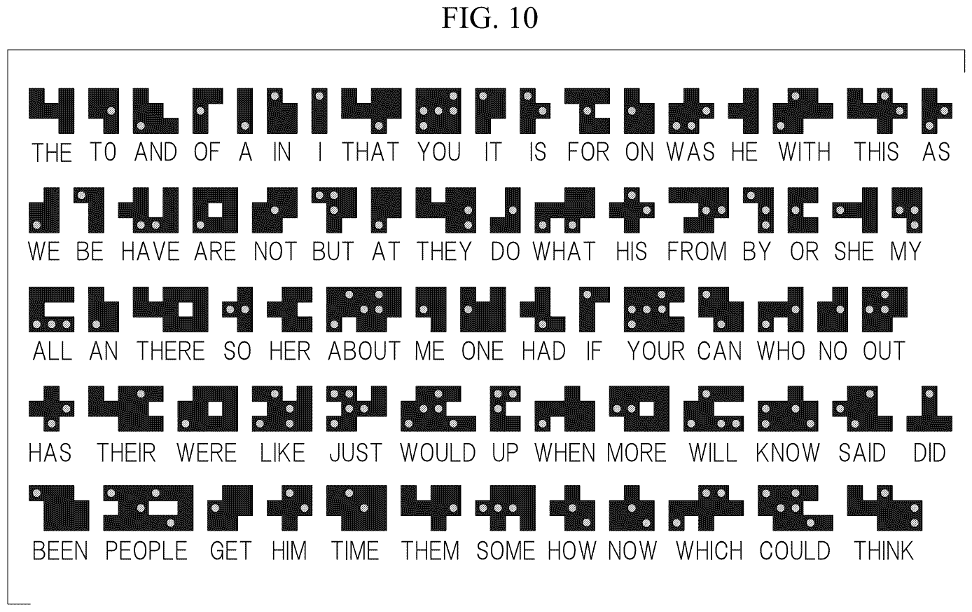

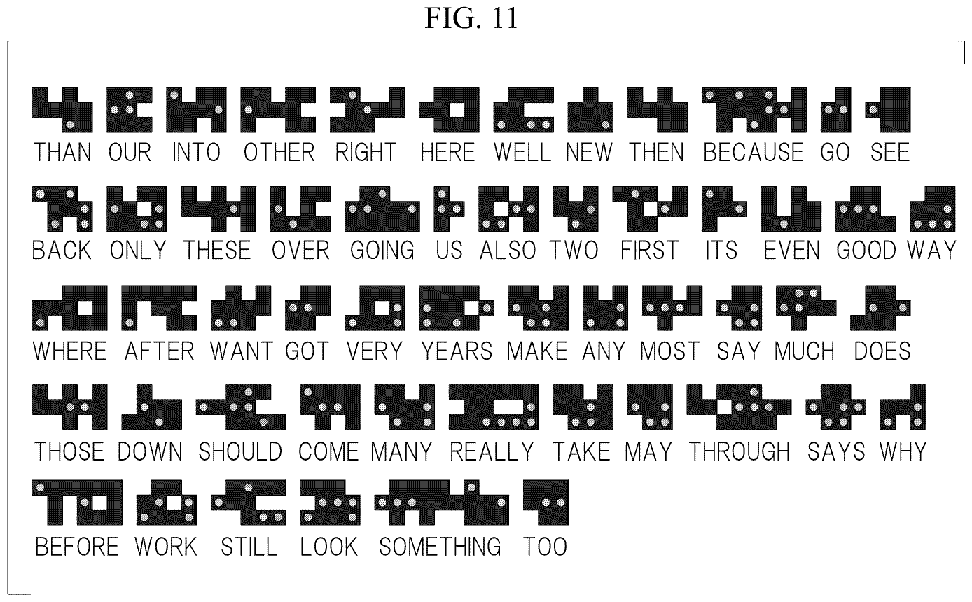

FIGS. 10 and 11 show examples in which common words in English are expressed by the character code described above with the alphabet written alongside. Each word is expressed as a logogram having a different shape. As described above, in addition to a word being legible by reading the character symbols 2 themselves constituting the character code, the character code can be read more easily by memorizing the meaning of the word in association with the shape of the logogram.

According to the input device 10 of the present embodiment, the character elements 1 can be successively input on the input keys 15a by slide input through use of the touch screen. In this case, since a word composed of the character symbols 2 can be understood as a logogram, the user can input the logogram across a plurality of input key columns rather than inputting it for each of the input key columns, in the case where he/she remembers the shape of the logogram.

While the user is performing an operation to the input keys 15a, an alphabet letter corresponding to the character symbol 2 that has been input may be updated and displayed, and the word may be fixed when moving to the next word.

Accordingly, words can be input with fewer strokes than when the alphabet letters are input in handwriting. For example, as shown in FIG. 12, in the case of inputting a character string of “IF THERE ARE” in the alphabet in handwriting, a minimum of eighteen strokes are required. In contrast, according to the input device 10 of the present embodiment, the character string can be input with a minimum of four strokes. Therefore, immediate and efficient input is enabled in comparison to the case of inputting the alphabet letters in handwriting, thereby saving time and effort.

In addition, when continuing slide input in the row direction, a new input key column is added frontward in the slide input direction and displayed on the display 12. The user can thereby continue input of the next character symbol 2 with a column of a space symbols left, without performing the operation of shifting the keyboard 15.

In addition, in the present embodiment, although a smartphone is exemplified as the input device 10, it is effective to apply the input device 10 to a device in which the display 12 is small and in which an input region is restricted, particularly such as a smartwatch. In other words, in a keyboard that enumerates and displays the alphabet letters, each key is smaller as the display 12 is smaller, making it extremely difficult to display and operate the key. In contrast, according to the input device 10 of the present embodiment, the character code can be input using a relatively wide region of the display 12 even if the display is small.

Note that according to the character code described above, a letter of the alphabet or a space symbol is assigned to each of the 27 types of character symbols 2 each composed of the three character elements 1 arranged longitudinally in a line. Thus, a plurality of the character symbols 2 constituting a word can be arranged closely with no gaps between one another in a lateral direction intersecting the longitudinal direction, which is a direction in which the character elements 1 are arranged.

In other words, there is an advantage in that, even if the character symbols 2 are brought close to each other, the character code of the present embodiment does not lose its meaning, since it does not contain a gap between the character symbols 2 unlike a barcode. In addition, since the character symbols 2 can be brought close to each other, the character symbols 2 can be arranged more densely in the lateral direction than the alphabet, which requires gaps between letters, or a barcode, thereby improving space efficiency. Therefore, a larger number of digits of characters can be arranged in a smaller space to contain a larger amount of information than that of a one-dimensional barcode or the like.

Furthermore, since the character code of the present embodiment is composed of the character symbols 2 each having a simple shape formed only by arranging the three character elements 1 longitudinally in a line, it can be easily read with a reading device, as it is composed of the character symbols 2 having a simple shape obtained only by arraying the three character elements 1 longitudinally in a line. In the case where the alphabet is read with a reading device, the recognition accuracy by OCR varies depending on the font, whereas the character code according to the present embodiment, which is composed of the character symbols each having a simple shape, enables accurate reading through simple pattern recognition.

Moreover, since a letter of the alphabet is assigned to a character symbol 2 arranged longitudinally in a line, a user can directly read the character code without using a reading device, unlike a barcode or a customer code. Therefore, the user can read the character code without the alphabet written alongside. In particular, even in a situation where a reading device cannot be activated, such as in a case where a system is down, the user is able to understand display content.

The character symbols 2 arranged longitudinally in a line also has an effect of reducing the burden on recognition by a computer or a user, since it has no unnecessary strokes unlike alphabet letters, thereby improving efficiency in reading a document. In addition, the required time on recognition of the character symbols by a computer can be shortened, thereby improving recognition accuracy.

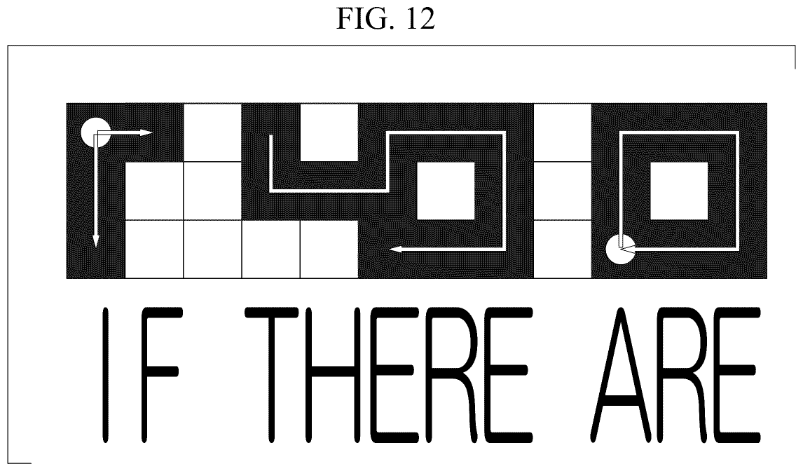

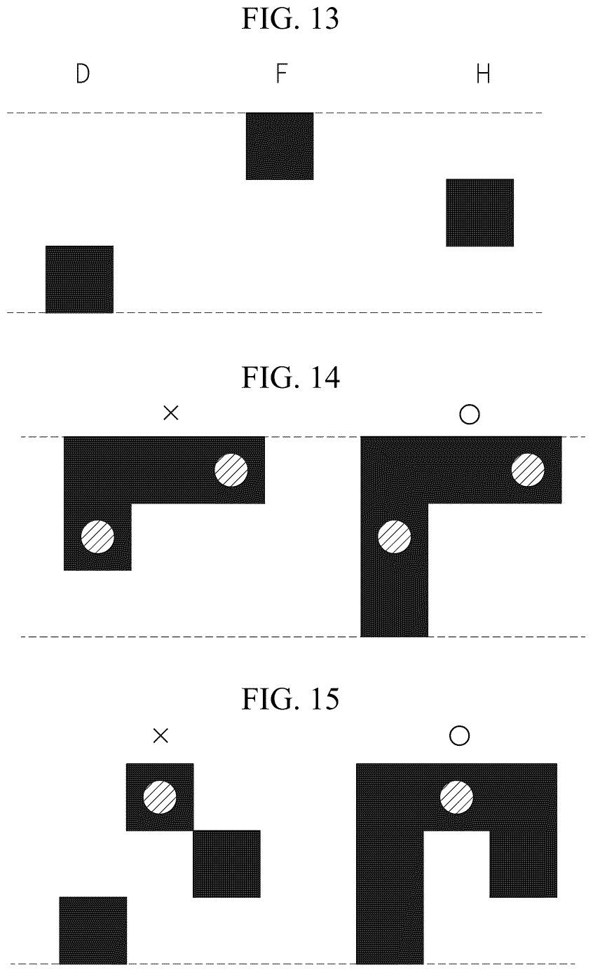

In addition, according to the above-described character code offers an advantage such that almost all words can be formed into logograms understandable on their own by means of the first optimization. For example, in the case where a word is composed of the character symbols 2 in the bottom row of FIG. 3, a character symbol composed of a single black-colored square or a character symbol in which two black-colored squares continue can be identified only after the lowermost position is indicated. For example, “D”, “F”, and “H” in the bottom row of FIG. 3 cannot be identified unless the lowermost position or the uppermost position is indicated with a guideline or the like as shown in FIG. 13. The same applies to “B”, “S”, and “V”; “C” and “G”; “M” and “W”; and “K” and “Q”, and the like.

Through the first optimization, as shown in FIG. 14, the lowermost and uppermost positions of the character symbols 2 can be clearly indicated due to the presence of a vowel or “Y” in a word, so that the user can easily identify the character symbols 2 and the word. In addition, there is an advantage in that meaning can be identified solely by a logogram depicted on blank paper without guideline, without using additional means such as guideline to identify the lowermost or uppermost position. Note that if an alphabet letter is written alongside with the character symbol 2, a marker such as a guideline is not required.

In addition, as shown in FIG. 15, through the second optimization, a logogram constituting a word can appear continuously without separation.

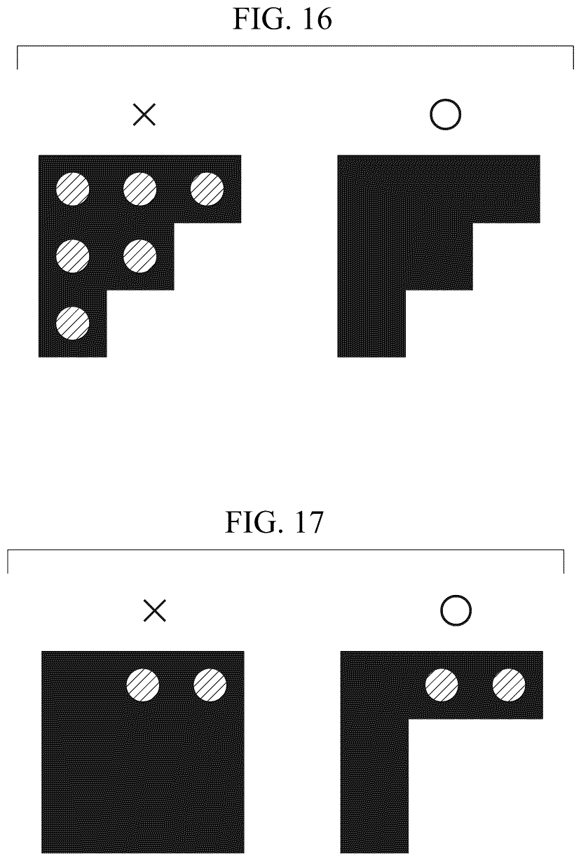

In addition, through the third optimization, as shown in FIG. 16, the number of the third character elements 1c in a word can be reduced, thereby ensuring that the user can read more easily and efficiently.

In addition, through the fourth optimization, as shown in FIG. 17, the first character element 1a can be less used in character symbols 2 in which a letter other than the vowels and “Y” appears frequently. This can eliminate such a logogram having a shape of a mere black-colored quadrangle and can lessen an excessive cognitive burden.

The character code according to the present embodiment can be applied to the following application purposes, for example:
Traffic signs for autonomous vehicles and drivers

This enables both human drivers and autonomous vehicles to interpret traffic instructions seamlessly.
Product labels for smart retail and logistics

This provides consumers with detailed information of products and assists automated systems in stock management and checkout operations.
Medical equipment and patient identification

This ensures accurate identification of patients by both medical staff and hospital robots.
Autonomous delivery and smart logistics

This enables both human delivery personnel and drones to accurately manage delivery operations using dually readable package labels.
Public transport systems and smart city infrastructures

This enhances public transportation signs and AI-driven traffic systems for commuters for work and school.
Warehouse/manufacturing automation

This enables streamlining of inventory and quality management performed by human workers and automated robots.
Traceability for supply chains

This enables tracing by quality inspectors and blockchain systems using dually readable labels for food and pharmaceutical products.
Construction/infrastructure projects

This ensures coordinated assembly using blueprints and components that are labeled for both workers and construction drones.
Aviation and airport services

This enables streamlining of processes performed by staff and sorting systems using dually readable boarding tickets and luggage tags.
Marine Navigation

This enables improvement in safety and docking efficiency using port signs legible to human and autonomous ships.
Military logistics and equipment management

This enables seamless tracing by soldiers and automated inventory systems using dually readable identifiers for equipment.

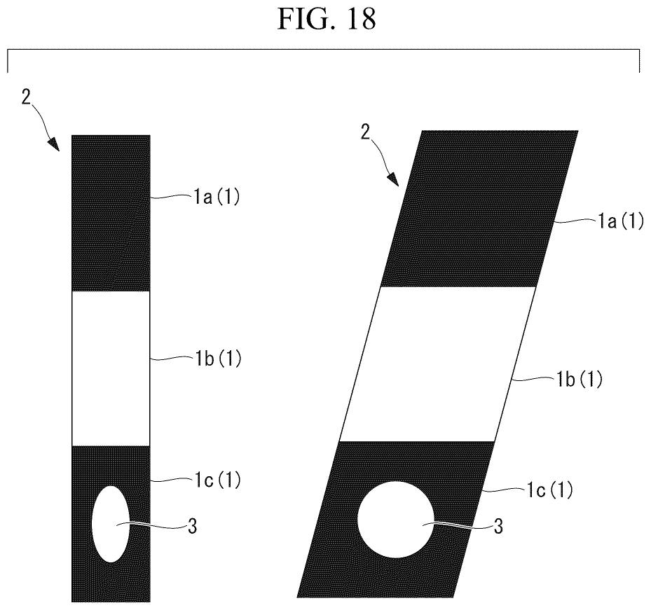

In addition, in the character code described above, the three types of the character elements 1a to 1c each composed of a square having an identical size are exemplified. Alternatively, the character elements 1 of any other shape may be employed. For example, as shown in FIG. 18, any parallelogram, such as a rectangle or a rhombus may be employed as the character element 1.

In addition, the first character element 1a and the third character element 1c are defined as having the same black-filled square, but they may be filled with another single color or multiple colors. In addition, the second character element 1b is defined as being filled with the same color as the background, but may be filled with another color distinguishable from the first character element 1a and the third character element 1c. In addition, the second character element 1b may be filled with the same color as the dot 3, the inside of which is filled with a color different from that of the outside.

In addition, a quadrangle having sharp corners has been exemplified as each of the character elements 1, whereas a quadrangle having rounded or chamfered corners may be employed.

In addition, the character symbol 2 may alternatively be formed by arranging the three character elements 1 laterally in a line, whereas, in the present embodiment, the character symbol 2 is formed by arranging the three character elements 1 longitudinally in a line. In this case, the character symbols 2 may be arranged longitudinally to form a word in a longitudinal direction.

In addition, the third character element 1c having the dot 3 of any shape, such as a polygon, star, or pictorial symbol, may alternatively be employed, whereas the third character element 1c having the circular dot 3 at the center of a parallelogram is exemplified.

In addition, the inside of the dot 3 of the third character element 1c is defined to be filled with a color different from that of the outside, but may alternatively be filled with the same color as the background color or may be transparent to the background color.

In addition, four or more character elements 1 may alternatively be combined into a line to constitute the character symbol 2, whereas, in the present embodiment, the three character elements 1 are combined into a line to constitute one character symbol 2.

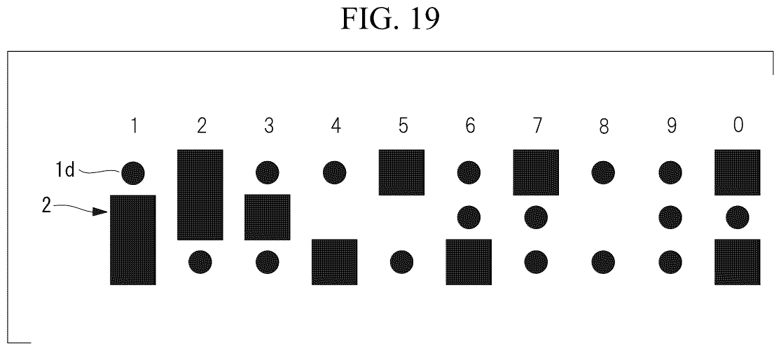

In addition, numbers and symbols may be arranged in text as they are without being contained in the character code of the present embodiment. In addition, a fourth character element 1d which is distinguishable from the first character element 1a to the third character element 1c may be used for a number or the like to be added as part of the character code according to the present embodiment. For example, as shown in FIG. 19, the fourth character element 1d obtained by inverting the third character element 1c, for example, may be used.

In addition, according to the input device 10 of the present embodiment, the keyboard 15 is set to display the second character element 1b by default. Alternatively, the keyboard 15 may display the first character element 1a by default. Since only the input key 15a to be switched to the second character element 1b or the third character element 1c is designated on the keyboard 15 on which the black-filled first character element 1a is displayed, it may be possible to further reduce strokes.

In addition, in the present embodiment, the memory 13 included in the input device 10 is exemplified; however, alternatively, an input system may be employed in which the memory 13 is included in a server connected to the input device 10 via a network. In this case, the input system according to the present embodiment includes the input device 10 and the server, and the server may acquire the character symbols 2 input to the input device 10, search for the corresponding alphabet letters in the memory 13, and output them. The input device 10 may receive the alphabet letters output from the server via the network, and display them on the display 12.

In addition, the server may include a processor. The processor of the server may cause the display 12 of the input device 10 to display the keyboard to allow a user to specify an input key, and may cyclically switch and display, for each input key, the three types of the character elements 1, upon specification of the input key.

In addition, in the present embodiment, English alphabet letters are exemplified as characters adopted, but this is not limited thereto. Letters from other languages (such as, for example, Japanese hiragana, Japanese katakana, Chinese, German, or Arabic script, etc.) may also be employed as characters.

In addition, in the present embodiment, the character code composed of the character symbols 2, each formed by arranging the three character elements 1 in a line, is exemplified; however, this is not limited thereto. In particular, a character code may be employed which is composed of up to N³ types of the character symbols 2, each of which is formed by arranging, in a line, N arbitrary character elements 1 selected from N different types of character elements 1 (N being a natural number), and by assigning a letter to each of the character symbols 2.

Although an embodiment and modifications of the present disclosure have been described above, the input device and the input system for a character code of the present disclosure are not limited to the embodiment and modifications described above and may be variously changed without departing from the scope of the present disclosure.

### REFERENCE SIGNS LIST

1 character element
1a first character element
1b second character element
1c third character element
2 character symbol
3 dot
10 input device
11 processor
12 display
13 memory
14 storage unit
15 keyboard
15a input key

1. An input device for a character code comprising 27 types of character symbols, each of which is formed by arranging, in a line, three arbitrary character elements selected from among three different types of the character elements, 26 letters of an alphabet and one space symbol being respectively assigned to the character symbols, the input device comprising:
at least one processor; and
a display,
wherein the processor is configured to:
display, on the display, a keyboard comprising a plurality of input key columns arranged side by side in a row direction, each of the input key columns being composed of three input keys arranged in a line in a column direction for inputting one of the character symbols, and allows a user to specify an input key, and
cyclically switch and display the three types of the character elements upon specification of the input key.

2. The input device according to claim 1, further comprising at least one memory, wherein
the memory stores the 27 types of the character symbols in association with the alphabet letters and the space symbol, and
the processor is configured to read out an alphabet letter stored in the memory in association with a character symbol that has been input to each of the input key columns by specification of the input key by the user, and display the alphabet letter in a region of the display other than the keyboard.

3. The input device according to claim 1, wherein
the 27 types of the character symbols are stored in association with the alphabet letters and the space symbol in at least one memory, and
the processor is configured to acquire an alphabet letter stored in the memory in association with a character symbol that has been input to each of the input key columns by specification of the input keys by the user, and display the alphabet letter in a region of the display other than the keyboard.

4. The input device according to claim 2, wherein a correspondence relationship stored in the memory between the character symbols and the alphabet letters and the space symbol is changeable by the user.

5. The input device according to claim 3, wherein a correspondence relationship stored in the memory between the character symbols and the alphabet letters and the space symbol is changeable by the user.

6. The input device according to claim 1, wherein the display is a touch screen.

7. The input device according to claim 6, wherein a plurality of the input keys of the keyboard that are adjacent to each other can be specified via a slide input.

8. The input device according to claim 1, wherein
the keyboard is slidable at least in the row direction, and
the processor is configured to add and display another input key column that follows rearward in a sliding direction when the keyboard is slid in the row direction.

9. The input device according to claim 2, wherein
the memory stores another keyboard for inputting a numeric value and/or a symbol, and
the processor is configured to switch between the keyboard for inputting the character symbol and the other keyboard and display the switched keyboard on the display.

10. An input system comprising a server that is connected, via a network, to an input device for a character code comprising 27 types of character symbols, each of which is formed by arranging, in a line, three arbitrary character elements selected from among three different types of the character elements, 26 letters of an alphabet and one space symbol being respectively assigned to the character symbols, wherein
the input device comprises a display,
the server comprises at least one processor, and
the processor is configured to:
display, on the display, a keyboard comprising a plurality of input key columns arranged side by side in a row direction, each of the input key columns being composed of three input keys arranged in a line in a column direction for inputting one of the character symbols, and allows a user to specify an input key, and
cyclically switch and display, for each of the input keys, the three types of the character elements, upon specification of the input key.

11. An input device for a character code comprising up to N³ types of character symbols, each of which is formed by arranging, in a line, N arbitrary character elements selected from N different types of character elements (N being a natural number), a letter being assigned to each of the character symbols.
